(19) United States
(12) Patent Application Publication
(10) Pub. No.: US 2022/0360595 A1
(43) Pub. Date: Nov. 10, 2022

(54) SYSTEM AND METHOD FOR SECURE WEB BROWSING

(71) Applicant: WEBGAP INC, Walnut, CA (US)

(72) Inventors: Guise BULE, Walnut, CA (US); Jun YANG, Walnut, CA (US)

(21) Appl. No.: 17/315,494

(22) Filed: May 10, 2021

(51) Int. Cl. H04L 29/06

(52) U.S. Cl. CPC H04L 63/1416; H04L 63/20

(57) ABSTRACT

A system and method for secure web browsing, through a combination of remote execution and local rendering of web pages. The process begins when a local computational device, controlled by a user, requests a web page for display. In the art known process, the request of the local computational device would be sent directly to a web host server, which would then provide all of the components of the web page. These components would then be sent to the local computational device, for rendering and also for execution locally. In the inventive process, the request of the local computational device is sent to a server gateway, which then sends the request to the web host server. The components of the web page are received by the server gateway. The server gateway then executes any scripts as needed, during the session that the user interacts with the web page through local computational device. The server gateway sends components of the received web page, optionally after any scripts have executed to provide additional data, to the local computational device. This process prevents any scripts or other executables from executing on the local computational device. The local computational device then renders the received components to create the web page for display on a web browser at the local computational device.

### FIELD OF THE INVENTION

There is provided a system and method for secure web browsing, and in particular, such a system and method for secure web browsing that features a combination of remote execution and local rendering of web pages.

### BACKGROUND OF THE INVENTION

Web browsers are a known entry point for malware, theft of sensitive information, phishing attacks and more. For example, a webpage that is accessed through a web browser on a local computer may introduce malicious scripts, and other scripts or functions that may not be deliberately malicious but that may pose security risks. Some organizations have required computers to be “air gapped”—that is, not connected to the internet. However, given the increasing amount of information and functions that are only available on the internet, preventing all connections to the internet is suboptimal.

Certain solutions have been introduced, to create an image of a webpage and only serve that image to the local web browser. However, this solution cannot adequately handle downloading of remote content, for example from a CDN (content delivery network). Also this solution cannot handle execution of scripts that may be required for secure and/or complete webpage functionality.

### BRIEF SUMMARY OF THE INVENTION

According to at least some embodiments there is provided a system and method for secure web browsing, through a combination of remote execution and local rendering of web pages. The process begins when a local computational device, controlled by a user, requests a web page for display. In the art known process, the request of the local computational device would be sent directly to a web host server, which would then provide all of the components of the web page. These components would then be sent to the local computational device, for rendering and also for execution locally.

In the inventive process, the request of the local computational device is sent to a server gateway, which then sends the request to the web host server. The components of the web page are received by the server gateway. The server gateway then executes any scripts as needed, during the session that the user interacts with the web page through local computational device. The server gateway sends components of the received web page, optionally after any scripts have executed to provide additional data, to the local computational device. This process prevents any scripts or other executables from executing on the local computational device. The local computational device then renders the received components to create the web page for display on a web browser at the local computational device.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions. The processor is configured to execute a predefined set of operations in response to receiving a corresponding instruction selected from a predefined native instruction set of codes.

Software (e.g., an application, computer instructions) which is configured to perform (or cause to be performed) certain functionality may also be referred to as a “module” for performing that functionality, and also may be referred to a “processor” for performing such functionality. Thus, processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions—which can be a set of instructions, an application, software—which are operable on a computational device (e.g., a processor) to cause the computational device to conduct and/or achieve one or more specific functionality. Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIG. 1 shows a non-limiting exemplary system for supporting secure web browsing;

FIG. 2 shows a non-limiting exemplary system for supporting secure web browsing with a plurality of web host servers and a plurality of user computational devices;

FIG. 3 shows a non-limiting exemplary system for supporting secure web browsing, with more details for webgap engine 134;

FIG. 4 shows a non-limiting exemplary method for operating the system as described herein; and

FIGS. 5A-5B show a non-limiting exemplary system featuring a cache farm according to at least some embodiments.

### DESCRIPTION OF AT LEAST SOME EMBODIMENTS

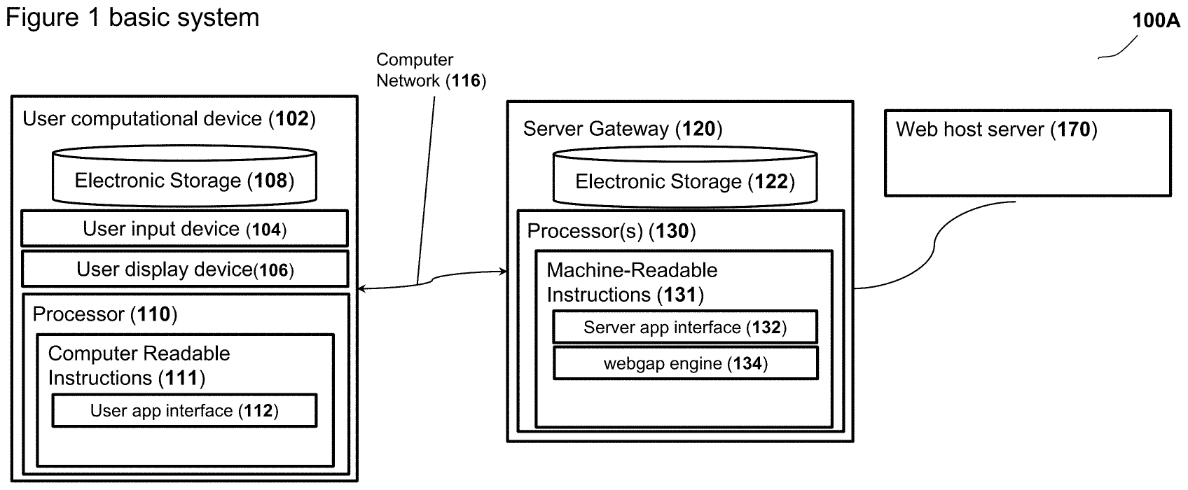

FIG. 1 shows a non-limiting exemplary system for supporting secure web browsing. As shown with regard to a system 100, there is provided a user computational device 102, which communicates through a computer network 116 with the server gateway 120. User computational device 102 features a user app interface 112, which preferably comprises a web page renderer and also a functional web browser. Optionally the web browser is present without a web page renderer as a normal web browser. The user may request a web page through user app interface 112, for example by entering a URL, clicking a link on another web page and so forth.

User app interface 112 then sends the request to server gateway 120, which receives the request through a server app interface 132. The request is then passed to a webgap engine 134. Webgap engine 134 then transmits the request to a web hosting server 170. Web hosting server 170 then sends the web page, including any associated scripts or other components, to webgap engine 134. Any components distributed through a CDN (content delivery network) are also sent to server gateway 120, as for any art known method for sending multiple components to a computational device requesting a web page, for assembling and rendering at that computational device.

Webgap engine 134 then receives all of the components and performs any actions needed, including causing any scripts to execute as necessary. The resultant prepared components are then transmitted to user computational device 102 for rendering by user app interface 112, optionally as a normal webpage by a normal web browser. As the user interacts with the web page as rendered by user app interface 112, requests are sent from user app interface 112 to webgap engine 134 to execute any scripts that are needed during this interaction, and the results are sent from webgap engine 134 to user app interface 112. Webgap engine 134 may comprise a chromium engine for example.

Data is then sent back from user app interface 112 to webgap engine 134 and is transmitted to web hosting server 170 as necessary. For example if the user fills out a form on the rendered web page displayed through user app interface 112, then the information provided through that form would be transmitted from webgap engine 134 to web hosting server 170 as though directly from a local user computational device to a web hosting server.

Optionally webgap engine 134 may check for personal and/or company data that is transmitted, for example to block such transmission according to a policy. Webgap engine 134 may also interact with an endpoint computer security system for enforcing security policies.

User computational device 102 also comprises a processor 110 and a memory 111. Functions of processor 110 preferably relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as a memory 111 in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, memory 111 is configured for storing a defined native instruction set of codes. Processor 110 is configured to perform a defined set of basic operations in response to receiving a corresponding basic instruction selected from the defined native instruction set of codes stored in memory 111. For example and without limitation, memory 111 may store a first set of machine codes selected from the native instruction set for requesting a web page from server gateway 120, second set of machine codes selected from the native instruction set for receiving web page components from webgap engine 134, and a third set of machine codes selected from the native instruction set for rendering the webpage through user app interface 112.

Similarly, server gateway 120 preferably comprises processor 130 and memory with machine readable instructions 131 with related or at least similar functions, including without limitation functions of server gateway 120 as described herein. For example and without limitation, memory 131 may store a first set of machine codes selected from the native instruction set for receiving the requested webpage from user computational device 102, a second set of machine codes selected from the native instruction set for transmitting the request to web host server 170 and for receiving a webpage therefrom, a third set of machine codes selected from the native instruction set for decomposing the received webpage, a fourth set of machine codes selected from the native instruction set for executing any necessary scripts and a fifth set of machine codes selected from the native instruction set for transmitting the web page components to user app interface 112 for rendering as a web page.

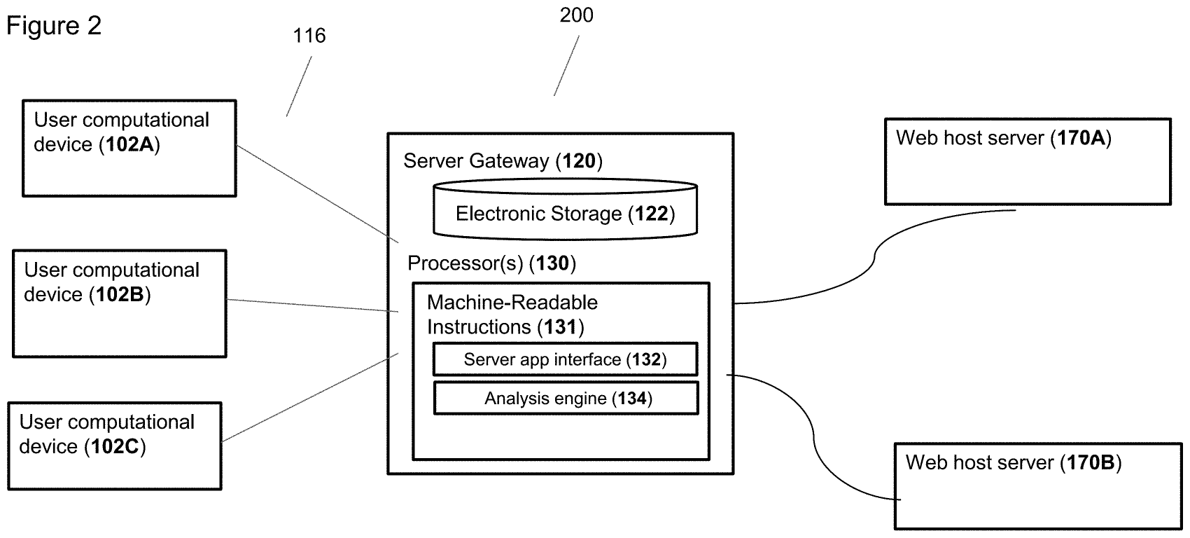

FIG. 2 shows a non-limiting exemplary system for supporting secure web browsing with a plurality of web host servers and a plurality of user computational devices. As shown in a non-limiting exemplary system 200, a plurality of local user computational devices 102A-102C are shown in simplified form, which may submit requests to view web pages and then to receive the components necessary to display such web pages. Figure components with the same reference numbers as for FIG. 1 have the same or similar function.

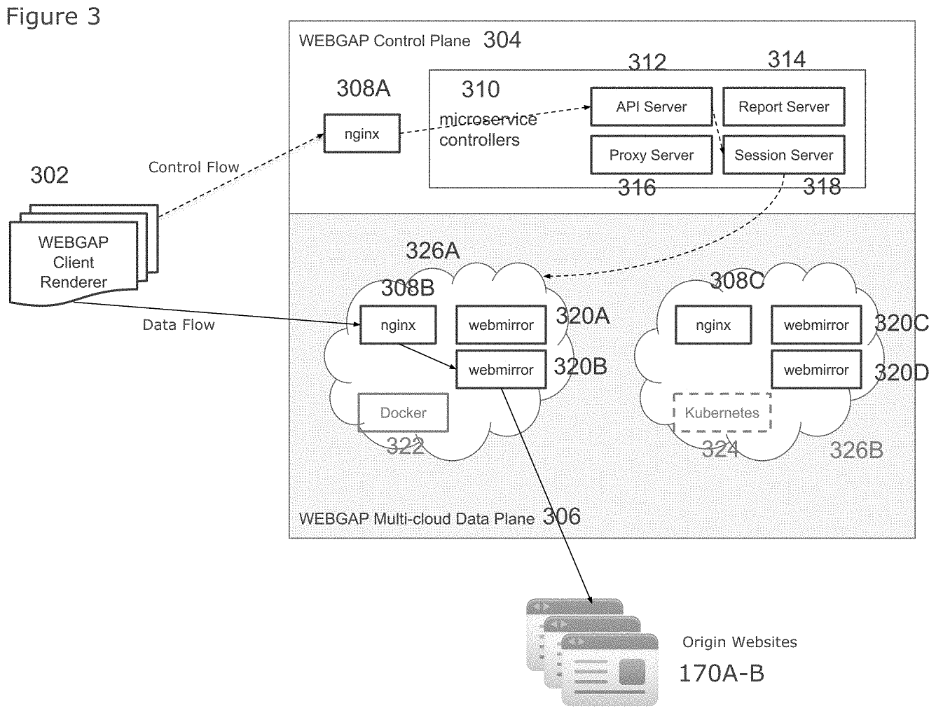

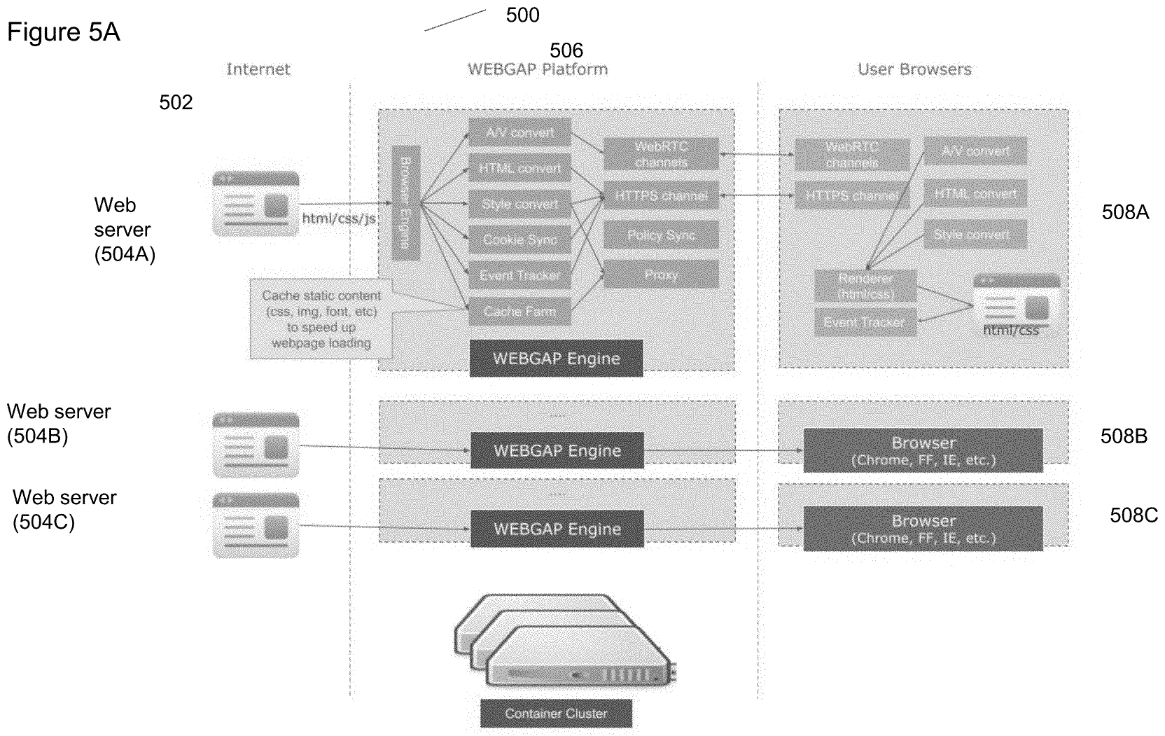

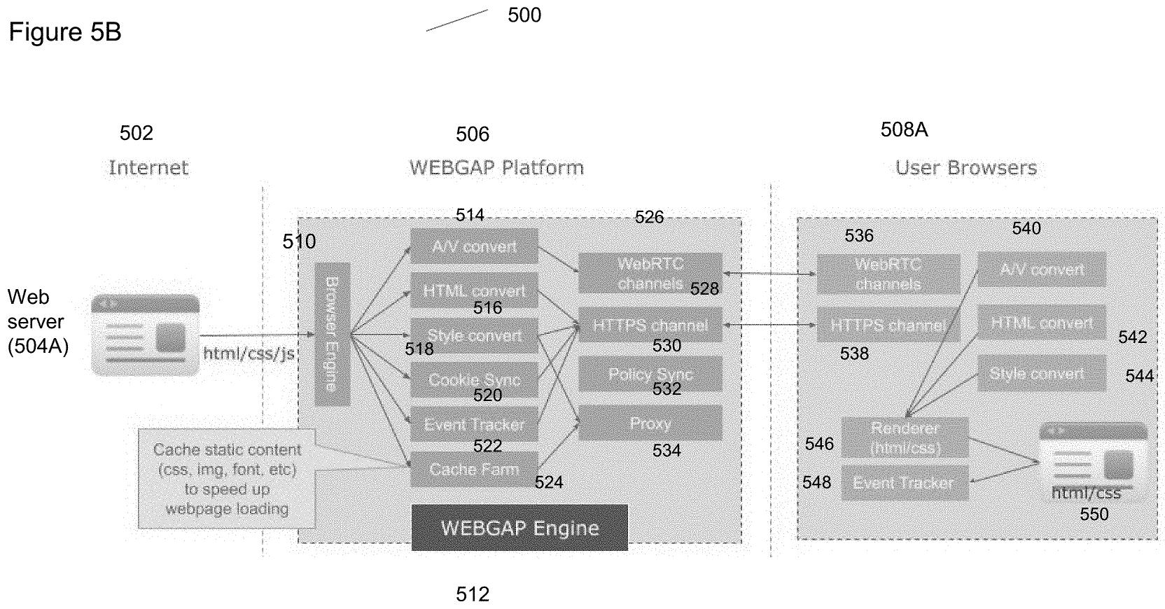

Webgap engine 134 is able to receive a plurality of requests from the plurality of user computational devices 102A-102C, and to transmit these requests to any suitable web host server 170, shown as a plurality of web host servers 170A and 170B. Preferably webgap engine 134 features scalable components, for example as described with regard to FIG. 3, to support scaling up or down of services as required. As described with regard to FIG. 5, webgap engine 134 is preferably structured to feature containerization, with stateless architecture for each container (except when running). Webgap engine 134 also preferably features a control plane which supports spawning and managing individual containers for individual users.

FIG. 3 shows a non-limiting exemplary system for supporting secure web browsing, with more details for webgap engine 134. As shown, webgap engine 134 receives a request for a webpage from a user computational device 102, sent from user app interface 112. The request is preferably received by a webgap control plane 304, which comprises a plurality of microservice controllers 310, shown as an API server 312. Microservice controllers 310 preferably supports such services as for how the client communicates with the back end services, login, authentication, and allocating resources required for remote browser capability. A report server 314 reports end user browsing records, potential security related events, issues in regard to policy and so forth. A proxy server 316 preferably supports proxy communication between the client and the container, for example to enable each container to handle each session and network communications. A session server 318 preferably manages the life cycle of each session.

Session server 318 then preferably starts a session by allocating or spawning a container; and then sending the web page request from the client to the allocated container through a data plane 306. The web page request causes a cluster 326 to spawn, of which a plurality are shown as clusters 326A and 326B for the purpose of illustration only and without any intention of being limiting. In this non-limiting example, the web page request, along with the session identifier, is received by cluster 326A. Within cluster 326A, one of a plurality of web mirrors 320 (that is, a remote browser engine, one of which handles each session) then receives the request and transmits it to an appropriate web host server 170 as shown. Web host server 170 then receives the request and transmits the web page to a web mirror 320, such as web mirror 320A.

Optionally webgap engine 134 comprises a plurality of web servers 308A-308C, which may also function for load balancing and/or may act as a proxy to direct traffic.

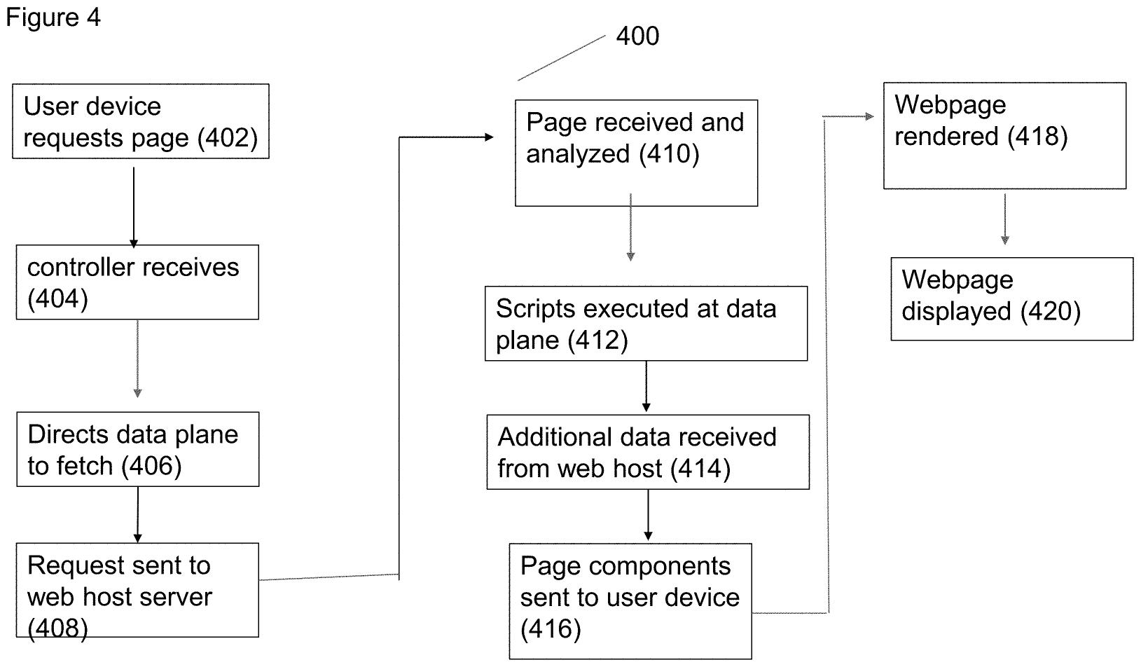

FIG. 4 shows a non-limiting exemplary method for operating the system of FIG. 3 as described herein. As shown in a method 400, the process begins at 402 when the user computational device requests a web page. The controller at the server gateway receives the request at 404. At 406, the data plane is directed to fetch the web page from the appropriate web host server. The request is then made at 408 to the web host server. At 410, the web page is received and analyzed at the data plane.

Next at 412, any necessary scripts are executed at the data plane. The scripts are preferably executed in real time without caching. Optionally saved user details, including but not limited to name, address, credit card details, passwords and other login details, are stored at the local client side web browser, although in some embodiments they may be stored at the data plane. As these scripts are executed, additional data is received from the web host server and/or another remote server such as a CDN at 414. The page components are then sent to the user computational device at 416. The webpage is then rendered at 418 and is displayed at 420. As the user interacts with the webpage, optionally steps 412-420 are repeated as necessary.

FIGS. 5A-5B show a non-limiting exemplary system featuring a cache farm according to at least some embodiments. FIG. 5A shows a system with a plurality of web servers and user browser instances, while FIG. 5B shows a part of that system in greater detail. Reference numbers are the same for both Figures.

As shown, a system 500 features a plurality of web servers 504A-504C, of which three are shown for the sake of description only. Each web server 504A-504C communicates through the Internet 502, to a webgap platform 506 and then to a user browser 508A-508C, of which three are shown for the sake of description only.

Webgap platform 506 preferably comprises a browser engine 510, a webgap engine 512 and an output controller 526. Browser engine 510 receives data from web server 504A, for example, and then sends instructions back to web server 504A. Webgap engine 512 then supports conversion and manipulation of the received data, for output through an interface controller 526, to user browser 508A, for example. User browser 508A sends back commands and instructions through interface controller 526 to webgap engine 512, which again performs the necessary conversion and manipulation of the received commands and instructions, before the commands and instructions are sent back to web server 504A through browser engine 510.

Webgap engine 512 preferably comprises an A/V converter 514, an HTML converter 516, a style converter 518, a cookie synchronizer 520, an event tracker 522 and a cache farm 524. HTML converter 516 is responsible for webpage DOM parsing. HTML converter 516 preferably stores a snapshot of the webpage and obtains the whole webpage for DOM structure. HTML converter 516 then preferably monitors for changes with a mutation observer.

Style converter 518 is responsible for CSS and resources handling, for example with regard to elements. Style converter 518 preferably parses the CSS, for example to search for an embedded URL, in order to provide a replacement with material that is downloaded from a remote server and then provided to user browser 508A.

Cookie synchronizer 520 handles cookies that would normally be accessed through user browser 508A. Such cookies are placed by web server 504A and may be required for optimal interactions with web pages served by web server 504A. To avoid having cookies from web server 504A be communicated directly to, and accessed directly from, user browser 508A, cookie synchronizer 520 synchronizes cookies with web server 504A. Optionally, cookie synchronizer 520 supports storage of cookies at webgap platform 506. Preferably and alternatively, for example for reasons of privacy, cookie synchronizer 520 encrypts the cookies and transfers them to user browser 508A for storage at the client side. When required for a subsequent session, cookie synchronizer 520 then requests the cookies back from user browser 508A if stored there or at a separate secured storage. Preferably cookies are transferred through HTTPS channel 530 and HTTPS channel 538.

Cache farm 524 is preferably for caching static content, including but not limited to CSS, HTML, fonts and the like to increase the speed of loading of the web content at user browser 508A.

Interface controller 526 preferably comprises a plurality of WebRTC channels 528, an HTTPS channel 530, a policy sync 532 and a proxy 534.

Each WebRTC channel 528 connects directly to a WebRTC channel 536 at user browser 508A, for direct peer to peer communication. Similarly, each HTTPS channel 530 connects directly to a HTTPS channel 538 at user browser 508A, for direct peer to peer communication. For such peer to peer communication, some type of server involvement is typically required, for example to exchange media and network metadata in order for the peer to peer connection to be created. Preferably a connection is made in advance from user browser 508A to webgap platform 506 to provide such media and network metadata. As a non-limiting example, if user browser 508A is operated by a computational device which is configured to connect to webgap platform 506 for web browsing, such an initial connection may provide such media and network metadata.

Proxy 534 preferably provides URLs to client-side (user browser 508A) for CSS and other processed static web resources, including but not limited to fonts, images and the like. The origin URL may not be operative at user browser 508A, for example because user browser 508A may not have session information so may not be considered to be logged in. The session information is preferably available only at webgap platform 506. Proxy 534 preferably obtains the images, fonts etc as though it were the client-side web browser (user browser 508A), which is then sent to the client-side and reconstructed.

Optionally policy sync 532 handles policy and security information, for example to check for malicious code and other issues regarding security. Policy sync 532 may optionally block certain websites if required by the policy.

User browser 508A also preferably comprises an A/V convert 540, an HTML converter 542 and a style converter 544, which communicate with a renderer 546 for rendering a web page 550. HTML converter 542 handles webpage DOM construction and is designed to operate in conjunction with parsing from HTML converter 516 at webgap platform 506, such that webpage DOM information is readily passed to user browser 508A. More preferably HTML converter 542 receives serialized DOM information from webgap platform 506 and then deserializes it.

Style converter 544 preferably receives style information, such as for example CSS information, and any associated resources, such as a downloaded image for example. The material is then combined and displayed through user browser 508A.

A/V converter 514 at webgap platform 506 preferably supports audio/video handling, for example with regard to conversion that is required for audio/video data to be sent through WebRTC channels 528 at webgap platform 506 to WebRTC channels 536 at user browser 508A. The audio/video data is then converted again at A/V converter 540 at user browser 508A, in order for the audio/video data to be displayed through user browser 508A. Supported conversions include but are not limited to media source extension (HTMLS standard), as well as actions required to establish such a connection, such as for example creating a beacon channel to exchange information. Alternatively, such audio/video data may be converted for transmission from HTTPS channel 530, at webgap platform 506, to HTTPS channel 538 at user browser 508A.

An event tracker 548 preferably receives information from web page 550, for example with regard to a click or button push event, and then provides this information to WebRTC channels 536 or HTTPS channel 538. The event information is then transmitted back to webgap platform 506, which passes it to web server 504A. Event tracker 548 is responsible for catching events on the client-side at user browser 508A) and replaying on the engine-side, through event tracker 522 at webgap platform 506. Event tracker 522 then plays the event, such that the event preferably ends up being played on both sides. Playing the event on both sides supports synchronizing the state of webpage activity on both sides, preferably even if event tracker 522 does not fully replay the event.

Scripts are preferably executed only at webgap platform 506 and not at user browser 508A. Scripts are preferably executed at webgap platform 506 on an as needed basis, for example, verifying that the user entered a valid email address in a form. For example, some scripts may be executed at webgap platform 506 after the user starts to interact with the web page at user browser 508A. Such script execution may be used to handle continuous scroll, web apps and so forth.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for remote access to a web page, comprising a web server for serving the web page, a local computational device, a server and a computer network for communication between said web server, said local computational device and said server; wherein said local computational device comprises a web browser for requesting the web page; wherein said server comprises a webgap engine for receiving the request from said local computational device, such that said local computational device is blocked from direct communication with said web server; wherein said server sends the request to said web server and receives components of the web page; wherein said webgap engine executes each required script and sends said components, with results of execution of each required script, to said local computational device, such that said local computational device is blocked from execution of each required script; and wherein said web browser of said local computational device displays said web page.

2. The system of claim 1, wherein said webgap engine further receives an event from said web browser and transmits said event to said web server, said webgap engine further receiving an event result from said web server, configuring at least one component of said web page accordingly and transmitting said reconfigured web page to said web browser.

3. The system of claim 2, wherein said server and said local computational device communicate according to at least one WebRTC channel for transmitting audio and/or visual data.

4. The system of claim 3, wherein said webgap engine further comprises a cookie synchronization module, such that at least one cookie is synchronized with said web server, wherein said cookie is stored at said local computational device and is sent to said webgap engine upon requesting said web page.

5. The system of claim 4, wherein said webgap engine further comprises a policy synchronization module, wherein information from said local computational device is examined for compliance with said policy before being transmitted to said web server.
